(19) United States
(12) Patent Application Publication
(10) Pub. No.: US 2009/0217084 A1
(43) Pub. Date: Aug. 27, 2009

(54) Digital Signage Redundancy

(76) Inventors: Christopher F. Ebbert, Minneapolis, MN (US); Clinton Ryan Groves, St. Louis Park, MN (US); Scott William Koller, Victoria, MN (US); John Jay Meyer, Lakeville, MN (US); Jeff David Hanson, Bloomington, MN (US)

Correspondence Address: FISH & RICHARDSON P.C., PO BOX 1022, MINNEAPOLIS, MN, 55440-1022, US

(21) Appl. No.: 12/037,804

(22) Filed: Feb. 26, 2008

(51) Int. Cl. G06F 11/20

(52) U.S. Cl. 714/5; 714/10; 714/E11.072; 714/E11.071

(57) ABSTRACT

The subject matter of this specification can be embodied in, among other things, a method that includes transmitting content to a location for presentation across a plurality of display devices that each present a portion of the content. The method includes receiving an indication that a first portion of the content managed by a first computing device is unable to be presented on a first display device. The method also includes transmitting a command to display the first portion on a second display device (where the second display device is configured to present a second portion of the content) if the received indication specifies that the first display device experienced a failure or transmitting a command that the first portion be displayed on the first display device using a second computing device if the received indication specifies that the first computing device experienced a failure.

### TECHNICAL FIELD

This instant specification relates to redundancy for digital signage systems.

### BACKGROUND

Digital signage is a form of information presentation in which monitors, or digital signs, display content. Unlike traditional printed signs, the content presented by digital signs can be updated or changed digitally without modification to the physical monitor. A digital signage system can include computing devices that generate content and corresponding displays that present the generated content. Also unlike traditional printed signs, digital signs may cease presenting content if either the computing device or the monitor fails.

### SUMMARY

In general, this document describes a failover system for mitigating component failure within a digital signage system.

In a first general aspect, a computer-implemented method is described. The method includes transmitting content to a location for presentation across a plurality of display devices that each present a portion of the content and receiving an indication that a first portion of the content managed by a first computing device is unable to be presented on a first display device. The method also includes transmitting a command to display the first portion on a second display device (where the second display device is configured to present a second portion of the content) if the received indication specifies that the first display device experienced a failure or transmitting a command that the first portion be displayed on the first display device using a second computing device if the received indication specifies that the first computing device experienced a failure.

In a second general aspect, a computer-implemented method is described that includes receiving an indication that content associated with a first computing device is unable to be presented on a first display device and determining whether the inability to present the content is based on a failure of the first computing device to generate the content or a failure of the first display device to present the content. The method includes transmitting a command to a second computing device to generate the content for presentation on the first display if the inability to present content is based on the failure of the first computing device and transmitting a command to a second display device to present the content associated with the first computing device if the inability to present the content is based on the failure of the first display device.

In a third general aspect, a system is described. The system includes an on-site controller to transmit content for presentation across a plurality of display devices that each present a portion of the content and receive an indication that a first portion of the content managed by a first computing device is unable to be presented on a first display device. The system also includes a second display device configured to present a second portion of the content. The second display device also presents the first portion if the first display device experiences a failure. Additionally, the system includes a second computing device configured to manage a second portion of the content. The second computing device manages the first portion of the content if the first computing device experiences a failure.

The systems and techniques described here may provide one or more of the following advantages. First, redundancy can be provided within a digital signage system so that a display failure can be mitigated. Second, redundancy can be provided within a digital signage system so that a computing device failure can be mitigated. Third, uptime for digital signage systems can be increased by implementing an automatic failover scheme to continue displaying all content even when a display or computing device fails. Fourth, service quality can be improved by alerting operators when remote components of a digital signage system fail.

The details of one or more embodiments are set forth in the accompanying drawings and the description below. Other features and advantages will be apparent from the description and drawings, and from the claims.

### DESCRIPTION OF DRAWINGS

FIG. 1 is schematic diagram of a digital signage system 100 having a redundant architecture according to one implementation.

FIG. 2 is a schematic of an exemplary digital signage system used to mitigate failures in display devices.

FIG. 3 is a flow chart of an exemplary method for mitigating a malfunction by a display in a digital signage system.

FIGS. 4A-C show exemplary redundant architectures for mitigating a display failure.

FIG. 5 is a schematic of an exemplary digital signage system used to mitigate failures in computing devices used to generate media for presentation on display devices.

FIG. 6 is flow chart of an exemplary method for mitigating the effect of a failed computing device within a digital signage system.

FIGS. 7A-C show exemplary redundant architectures for mitigating a computing device failure.

FIGS. 8-10 show exemplary arrangements using video switches to connect end-point viewers with displays.

FIG. 11 is a schematic diagram of a general computer system.

Like reference symbols in the various drawings indicate like elements.

### DETAILED DESCRIPTION

This document describes systems and techniques for mitigating failures of computing and display devices within a digital signage system. In some implementations, a digital signage system includes several monitors, or displays, that present media that is generated or managed by computing devices. A controller (e.g., a server) can manage the computing devices, the monitors, or both. In some implementations, if a computing device experiences a failure so that it cannot transmit media to an associated monitor, the controller requests that a different computing device transmit the media to the monitor associated with the failed computing device.

In another implementation, if a monitor experiences a failure so that it cannot present media from a computing device, the controller can request that a different monitor (that is associated with a different computing device) display the media. For example, if a monitor that displays content from a first source fails, a working monitor that typically displays content from a second source may display content from both the first and second sources in rotation.

In some implementations, the digital signage system can include displays that each present related content. For example, a first display may present content that includes stock information for companies A-N and a second display may present content that includes stock information for companies O-Z. The redundancy architecture can permit all of the related content to be displayed (e.g., the stock information for all companies A-Z) even if one or more components of the digital signage system fail.

The related content displayed on each of the displays can include non-redundant information that would be absent if a component of the digital signage system failed and the failure was not mitigated (e.g., menu items for a food establishment, airport flight information, class scheduling information, etc.).

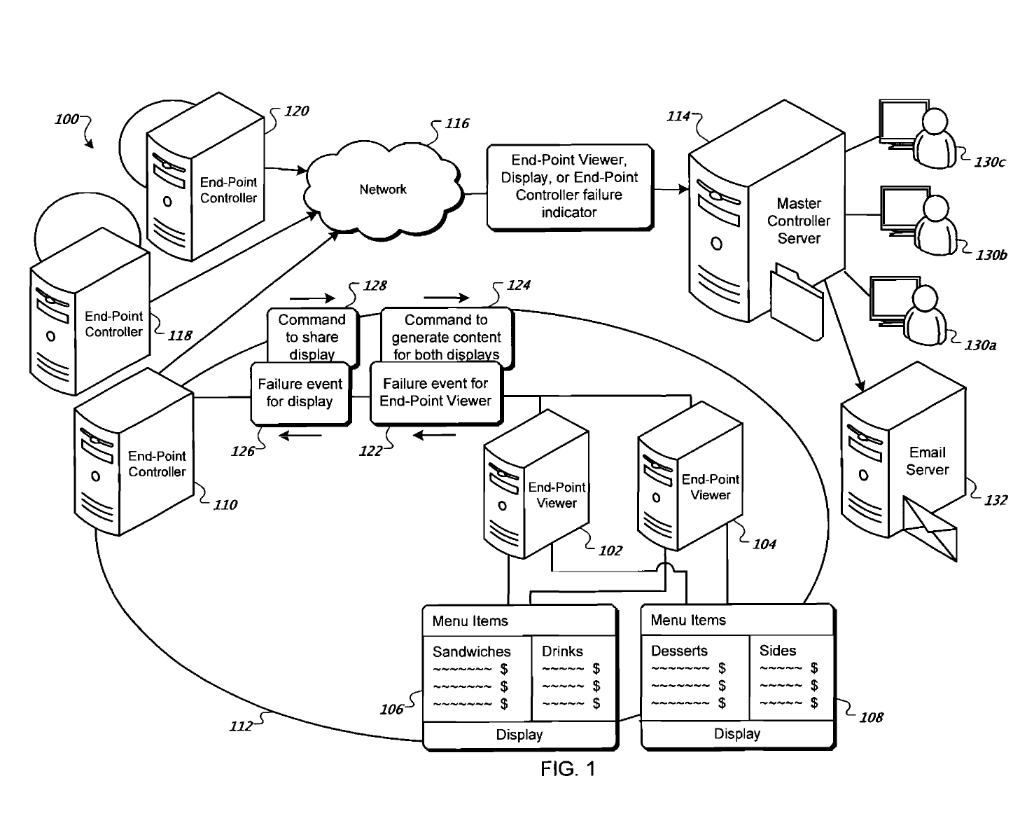

FIG. 1 is schematic diagram of a digital signage system 100 having a redundant architecture according to one implementation. The digital signage system 100 includes end-point viewers 102, 104 that are associated with displays 106, 108, and an end-point controller 110 that manages the end-point viewers 102, 104. In some implementations, the end point viewers are computing devices that include media players that generate graphics for presentation on the displays.

An “end-point” may be a location in which a digital sign is deployed—and is somewhere that is on-site with the signage rather than at a central location. For example, the end-point 112 may be a quick serve restaurant and the digital signs can display menu items for the quick serve restaurant. In some implementations, each end-point viewer is primarily associated with a display and transmits information for presentation on that display. For example, the end-point viewer 102 transmits information including menu items such as sandwiches, drinks, and associated prices to the display 106.

In some implementations, a master controller server 114 manages several end-points. For example, the master controller server 114 can receive information from multiple end-point controllers 110, 118, and 120 via a network 116 such as the Internet. The information can include alerts that an end-point viewer, a display, or an end-point controller has experienced a malfunction.

The displays 106 may also included embedded players that are mounted to or in the displays themselves, that may serve wholly or partly as end-point devices. In particular, in some implementations, an embedded player may be programmed to display locally-stored content when a communication link to a separate end-point viewer is broken. In such a manner, some information—perhaps, but not necessarily less animated and less complete than the information from the end-point viewer—may be displayed even when a link fails. For example, in a movie theatre application, an end-point viewer may be programmed to provide video from a particular movie that is about to play along with textual descriptions relating to the movie. Such a system may also switch to display the next movie to be opening up. An embedded player may instead store a basic fixed image from each movie poster along with certain information the corresponding movie, and may simply cycle through the various movies if the communication link is broken.

The end-point controller 110 can receive messages indicating failure events from the displays 106,108 and the end-point viewers 102, 104. Additionally, the end-point controller 110 can take action to mitigate the failures. For example, if the end-point controller 110 receives a failure event 122 that is associated with the display 106, the end-point controller 110 can transmit a command 124 that initiates a set of actions so that the content displayed on the malfunctioning display 106 is presented on the display 108, which is functional. This may permit full presentation of the content regardless of a display failure. For example, the display 108 can present the sandwiches and drink menu items in rotation with the desserts and sides menu items.

In another example, the end-point controller 110 receives an indication 126 that a failure event associated with an end-point viewer has occurred. In response, the end-point controller 110 can transmit a command 128 that initiates a set of actions so that a working end-point viewer takes responsibility for displaying content previously displayed by the malfunctioning end-point viewer. For example, if the end-point controller 110 receives an indication that the end-point viewer 102 is malfunctioning, the end-point controller 110 can transmit a command that the end-point viewer 104 should generate content including the sandwich and drink menu items and transmits this content to the display 106.

The end-point viewer 104 can maintain its transmission to the display 108 so that the dessert and side menu items are also displayed. For example, the end-point viewer 104 can rotate the menu items presented on the display 108 so that content including the sandwich and drink menu items is replaced with content including the dessert and sides menu items.

In some implementations, after receiving a message indicating a malfunction of a display or end-point viewer, the end-point controller 110 can transmit information to the master controller server 114 indicating that the malfunction has occurred. The master controller server 114 can then transmit alerts to users 130A-C that include information about the malfunctioning devices. For example, the master controller server 114 can transmit a message to an operator 130A that the display 106 has failed and needs to be replaced. The operator 130A can then dispatch a service technician to the end-point 112 to replace the malfunctioning display. In another example, a master controller server can transmit the information to another server such as an e-mail server 132, which in turn transmits the information to a list of predetermined e-mail addresses.

In another implementation, the master controller server 114 can also receive alerts indicating that an end-point controller has malfunctioned. These alerts can be forwarded to the users 130A-C or other systems such as the email server 132 as described above.

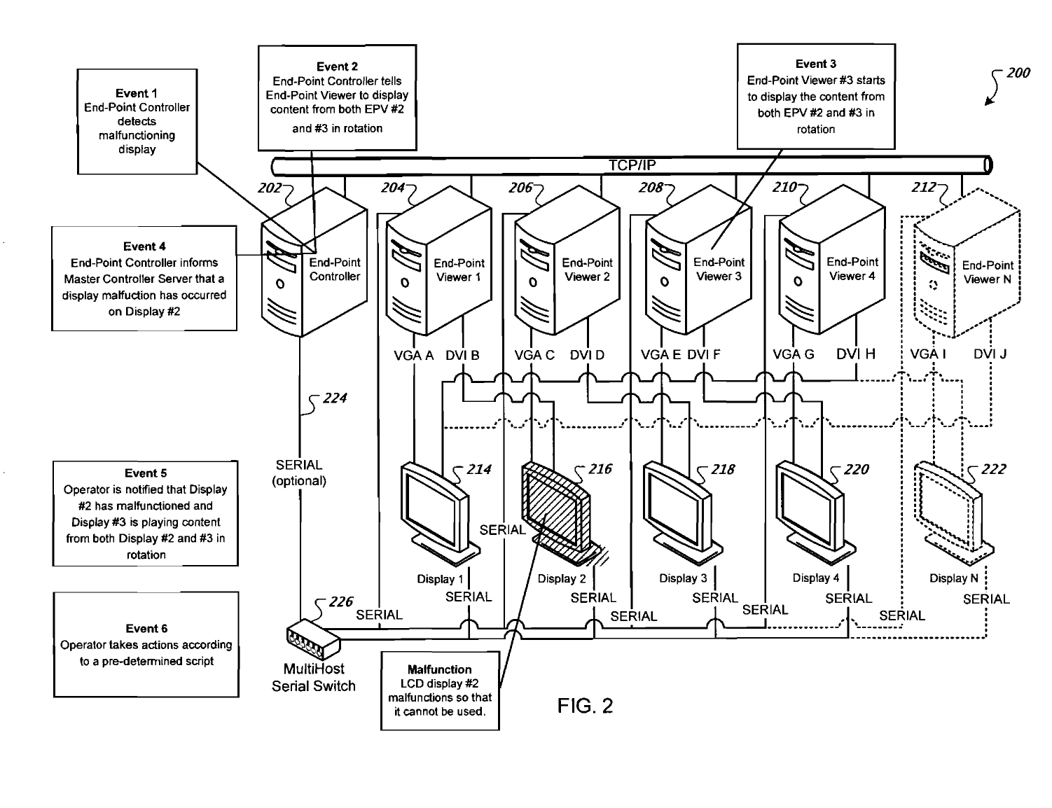

FIG. 2 is a schematic of an exemplary digital signage system 200 used to mitigate failures in display devices. In the illustrated example, an end-point controller 202 is networked to end-point viewers 204, 206, 208, 210, and 212, although the end-point controller can be networked to any number of end-point viewers. In some implementations, the end-point controller 202 can be networked to the end-point viewers using a networking standard that implements Transmission Control Protocol/Internet Protocol (TCP/IP) such as Ethernet IEEE 802.3 or wireless local area network (WLAN) IEEE 802.11.

In the example of FIG. 2, the end-point viewers 204, 206, 208, 210, and 212 are connected to displays 214, 216, 218, 220, and 222 using Video Graphics Array (VGA) and Digital Visual Interface (DVI) connections. In FIG. 2, each of the end-point viewers is connected to two displays. For example, the end-point viewer 204 has an output A that is connected to the display 214 though a VGA connection. The end-point viewer 204 also has an output B that is connected to the display 216 through a DVI connection.

In some implementations, each of the displays is connected to two end-point viewers. For example the display 214 has an input A that is connected to the end-point viewer 204 though a VGA connection and also has an input B that is connected to the end-point viewer 210 through a DVI connection.

The end-point controller 202 can optionally connect to the displays, the end-point viewers, or both through an additional serial network 224. For example, the end-point controller 202 can connect to a multihost serial switch 226 that in turn connects to one or more of the displays and the end-point viewers. In some implementations, the end-point controller 202 transmits commands through the serial network to the displays in order to execute functions such as controlling a display's presentation properties (e.g., contrast, hue, etc.) or requesting that a display change sources of input (e.g. switching from accepting a video signal from input A to accepting a video signal from input B).

The end-point controller can also transmit commands to the end-point viewers through the serial network 224. In some implementations, the commands can include instructions to switch an output of the end-point viewer. For example, the end-point controller 202 can instruct the end-point viewer 204 to transmit media content generated by the end-point viewer 204 through an output B (a DVI output) instead of a through an output A (a VGA output). In other implementations, the TCP/IP connection between the end-point controller 202 and the end-point viewers can be used to instruct the end-point viewers to switch outputs.

In an example of the operation of system 200, in FIG. 2, the display 216 malfunctions. The end-point controller 202 detects that the display 216 has malfunctioned and is no longer able to present graphics created by the end-point viewer 206. Such detection may occur by a variety of mechanisms. For example, automatic detection may occur by monitoring a two-way communication link (e.g., a serial link) for an error signal, or the absence of a proper operation signal, or by monitoring electrical draw by the device for changes (although such electrical draw monitoring may only detect certain problems). The detection may also include a manual component, such as by providing a button on the device that a user can press, or a wall-mounted control pad (much like a security system control panel) by which a user can manually report problems with displays.

To mitigate this failure, the end-point controller 202 can, for example, transmit a request to a different end-point viewer such as the end-point viewer 208 to start displaying content for both the end-point viewer 206 (which is connected to the malfunctioning display) and content that it normally displays. The display 218 that is connected to the end-point viewer 208 can present both pieces of content. For example, the content associated with each of the end-point viewers can be presented on the display 218 in rotation (e.g., scrolling the content or replacing content (in whole or in part) at intervals so that both pieces are presented).

In some implementations, some of the content presented by a functioning display may be designated as essential to display continuously, or without cycling with other content. For example, if the system 200 of FIG. 2 is implemented in a quick-serve restaurant, the displays may present a menu board for the restaurant. A master controller server (or other system component) can designate a first portion of the menu board that displays the restaurant's name as mandatory to display, a second portion of high profit menu items such as drinks mandatory to display, and the remaining portions as menu items that can be rotated in the event of a component failure. In some implementations, the mandatory content is designated as such using meta data associated with the content and generated by the master controller server (or other system component). For example, if the content is passed in an XML (eXtensible Markup Language) format, the content can include an XML tag such as <mandatory></mandatory> that specifies the beginning and end of content that is preferably continuously displayed.

In some implementations, the mandatory content remains on a display while other non-mandatory content is displayed in rotation. For example, the restaurant name and drink menu can remain on the display 218 if the display 216 fails, and the other menu items previously presented on both displays 216, 218 can be presented in rotation on the working display 218. In some implementations, the mandatory content can be repositioned so that it is grouped together. Similarly, the non-mandatory content can be grouped so that it is presented is a defined region of the working display.

In other implementations, the mandatory content is grouped together and presented on one display while non-mandatory content is grouped together and presented in rotation on another display. For example, the system 200 can include the three displays 214, 216, and 218, which each present content designated as mandatory and non-mandatory. If the display 216 fails, the mandatory content presented by all three displays can be grouped and transmitted for static presentation to the display 214, while the non-mandatory content is grouped together and transmitted for presentation in rotation on the display 218.

Also, certain data that is initially on two functioning displays can be displayed simultaneously on one display when the other display fails. For example, the post-failure display may involve shrinking each piece of content so as to fit all of the content on a single display. Also, certain part of the content on a display may be considered mandatory while other content on the same display is non-mandatory. For example, in a quick serve restaurant, the name and price for food items may be mandatory, while images of the items, other graphics, animations, or upsell content (i.e., content that is used to encourage customers to buy additional items) can b considered non-mandatory. The initial displays may be established so that the mandatory content consumes half a display, and the non-mandatory content consumes the other half. If one display out of two fails, the non-mandatory content form each display can be suppressed, and the mandatory content alone can be display, i.e., with the after-failure display showing the content from one pre-failure display in its top half and the content from the other pre-failure display in its bottom half.

Also, although the examples here have generally been described with respect to failure of one display with a transfer to another display, any appropriate number of pre-failure and post-failure displays may be accommodated. As one example discussed in more detail below, a controllable switch such as an HDMI switch, can be used to route display signals from one or more end point views to one or more displays. The particular relationships may be by an N×N matrix, where there is nominally one controller for each display, or an M×N matrix, where the number of controllers differs from the number of displays. Also, one end point viewer may be associated with multiple displays, such as by providing more than one graphics controller or a graphics controller with multiple inputs on in a single controller.

In addition, although the display of information here is shown as occurring on multiple displays that are all generally the same size, the display may alternatively or additionally occur audibly. For example, music or other audible information may accompany the display of static or dynamic (e.g., animations) information on the displays. Also, different forms of information may be presented on displays of varying size. For example, in a quick serve restaurant setting, general menu board information may be shown on large displays (e.g., 42 inches or larger) behind the workers. In contrast, context-sensitive information may be displayed on smaller displays (e.g., 20 inches or smaller) at each point of sale location, for example, by displaying coffee or a particular promotional item after the corresponding POS terminal has received a sandwich order. When a display in such a system fails, such as when one of the large displays fails, certain of the content from the large display may be transferred to the smaller displays—such as a list of the most popular items and their prices.

In some implementations, the end-point controller 202 can transmit information to a remote server such as the master controller server 114 of FIG. 1. For example, the end-point controller 202 can inform the master controller server 114 that the display 216 has malfunctioned. The master controller server 114 can then execute a series of actions, such as notifying an operator of the failure and of the location of the failed device. Additionally, the master controller server 114 can inform the operator that the display 218 is successfully presenting the content associated with the end-point viewers 206, 208.

In some implementations, the master controller server 114 can initiate the presentation of a script to the operator, where the script indicates one or more actions that the operator should perform. For example, the script can instruct the operator to call the end-point (e.g., a quick serve restaurant) to notify personnel at the end-point of the failure. The script can instruct the operator to ask the personnel a series of troubleshooting questions in order to repair the malfunctioning component (e.g., “Is the monitor's power cord plugged into a power outlet?”). In another example, the script can include instructions that the operator notify the personnel that the failure has been detected and that a service technician has been dispatched to the site.

In other implementations, an artificial intelligence (AI) application can initiate actions based on information received from an end-point controller 202. For example, the AI application can run a set of rules against the received information to determine whether and when to send out a technician to a remote site. In another example, the AI application can communicate with personnel at the remote site in order to troubleshoot malfunctioning equipment. For example, the AI application can initiate a chat, a phone call, or an email message that asks personnel to reboot a particular end-point viewer that is malfunctioning.

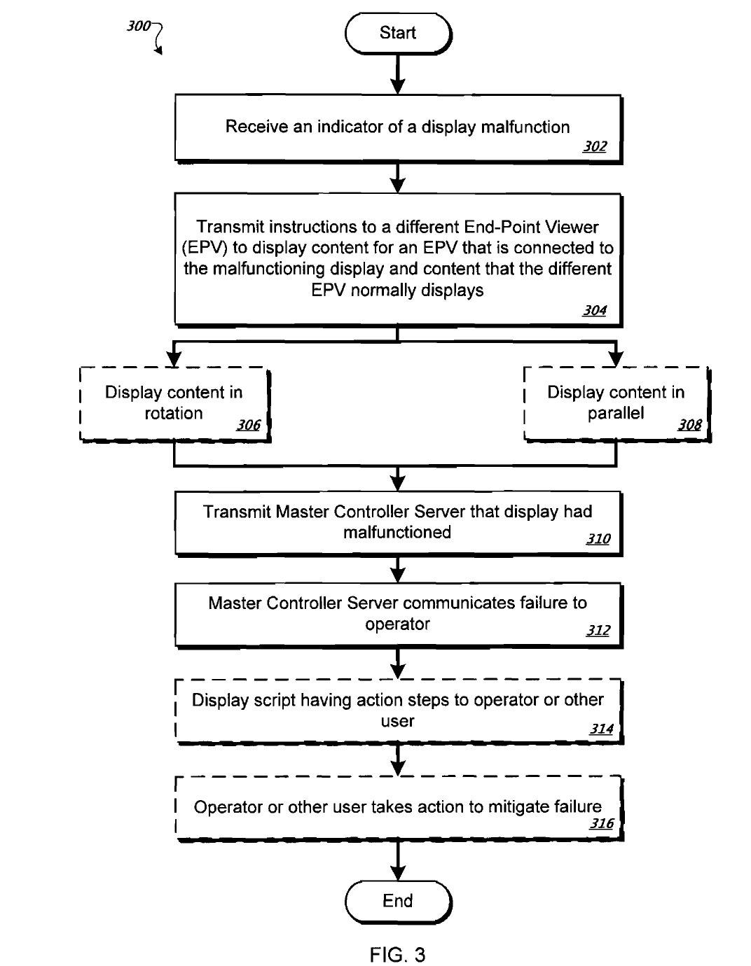

FIG. 3 is a flow chart of an exemplary method 300 for mitigating a malfunction by a display in a digital signage system. The method 300 may be performed, for example, by a system such as the systems 100 and 200. For clarity of presentation, the description that follows uses these systems as the basis of an example for describing the processes. However, another system, or combination of systems, may be used to perform the method 300.

In step 302, an indication of a display malfunction is received. For example, an end-point viewer A can detect that a monitor A is not currently powered. The end-point viewer A can transmit an indication that the monitor A is not powered to an end-point controller.

In step 304, instructions can be transmitted to a different end-point viewer B to display content for the end-point viewer A as well as content normally displayed by the end-point viewer B. For example, in response to receiving an indication that monitor A has malfunctioned, the end-point controller can transmit a command to the end-point viewer B instructing the end-point viewer B to display content A associated with end-point viewer A on a monitor B. End-point viewer B can then transmit content A as well as content B (which is normally transmitted to the monitor B) to the monitor B for display.

In step 306, content can be displayed in rotation. For example, the end-point viewer can transmit content A so that it is cycled with content B on the monitor B. Alternatively, the content can be displayed in parallel as indicated in step 308. For example, content A can be displayed simultaneously with content B in a split screen format on the monitor B.

In step 310, a message is transferred to a remote server that a display has malfunctioned. For example, a remote server such as the master controller server 114 can manage several end-points and the infrastructure associated with the end-points. The end-point controller can transmit a message to the master controller server that monitor B has failed. In some implementations, the message can include an identifier (ID) associated with the failed monitor and a location or ID for the end-point (e.g., the Minneapolis/St. Paul International Airport, Terminal D, Monitor 414489).

In step 312, the remote server alerts an operator of the failure. For example, the master controller server 114 can transmit an alert that monitor B has failed to an email server that emails the alert to a predetermined set of email addresses. In another example, the alert can be transmitted to a user, such as system operator using a client logged into (or otherwise in communication) with the master controller server.

In optional step 314, a script having action steps can be displayed to the operator or other user. In some implementations, in addition to alerting the operator that monitor B has failed, the master controller server 114 can display a script to the operator that includes a set of steps or actions that the operator may take. For example, the script can include a phone number of the facility associated with the end-point and a set of trouble shooting questions or prompts. In another example, the script can include a map to the location for use by a field maintenance agent in locating the end-point having the faulty monitor.

In optional step 316, the operator or other user takes action to mitigate the failure. For example, the operator can use the script to call the facility and attempt to determine if the monitor B can be returned to service without sending a field operative to repair or replace the monitor. In another example, the field maintenance agent can be dispatched to replace or troubleshoot the monitor B on site. After step 316, the method can end.

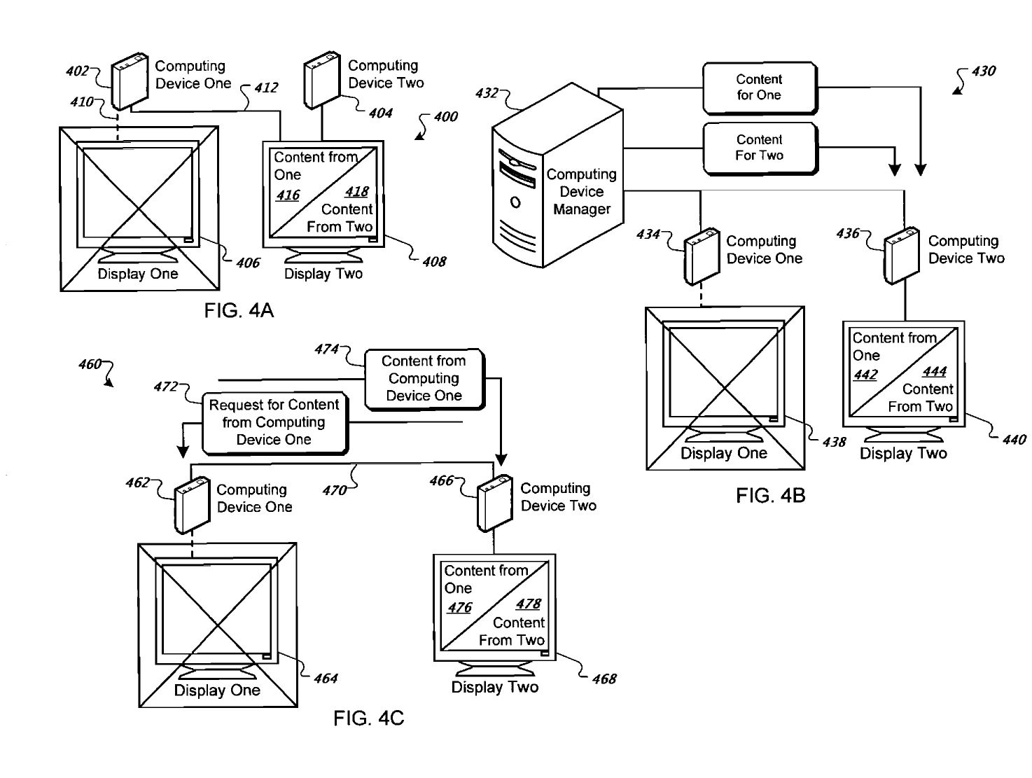

FIGS. 4A-C show exemplary redundant architectures 400, 430, 460 for mitigating a display failure. FIG. 4A is a schematic diagram showing an exemplary redundancy architecture where an output for a computing device one 402 is switched to a working display in the event of a display failure. The architecture 400 includes the computing device one 402, a computing device two 404, a display one 406, and a display two 408. The computing device one 402 has a primary output 410 and a secondary output 412. When display one 406 is functioning, the computing device one 402 outputs media for presentation via the primary output 410, which connects the computing device one 402 to the display one 406.

If the display one 406 malfunctions (indicated in FIG. 4A by an “X” over display one), the computing device one 402 can switch output so that media managed (e.g., media that is generated or stored) by the computing device one 402 is transmitted through the alternative output 412 to the display two 408. The display two 408 is connected to the computing device two 404 through a primary output 414 of the computing device two 404.

In some implementations, the display two 408 can present content 416 from the computing device one 402 and content 418 from the computing device two 404. For example, the display two 408 can present the contents 416, 418 in parallel on the same screen. In some implementations, a processor within the display two 408 can manage the presentation of contents 416, 418 so that the content is displayed as in a split screen format.

In another implementation, the computing device two 404 transmits its content 418 for a predetermined period of time and then ceases the transmission. The computing device one 402 then transmits its content 416 for predetermined period of time. In this way, the computing devices one and two can alternate in displaying their respective content.

In yet another implementation, the computing devices one and two continue to output media to the display two 408, but the display two 408 switches input so that the display two accepts input for display from only one of the computing devices at a time. For example, the display two 408 can have a primary and secondary input (e.g. a VGA and DVI input), which corresponds, respectively, to the primary output 414 from computing device two 404 and the alternative output 412 from the computing device one 402. The display two 408 can switch between inputs so that the display presents input received from one of the computing devices for predetermined period of time and then displays input from the other computing device for predetermined period of time. The display two 408 can self determine when to switch, or it can receive commands from another computing device such as the computing device one 402, the computing device two 404, or an end-point controller (not shown in FIG. 4A).

FIG. 4B shows the exemplary redundancy architecture 430, where a computing device coupled to a working display takes responsibility for displaying content previously managed by another computing device if a display that is associated with the other computing device fails. The redundancy architecture 430 includes a computing device manager 432 that transmits information to a computing device one 434 and a computing device two 436 for presentation on a display one 438 and a display two 440, respectively.

In some implementations, the computing device manager 432 can be an end-point controller as discussed previously. The computing device manager 432 can transmit information (content for display or information used to generate the content for display) to the computing device one 434. Similarly, the computing device manager 432 can transmit information to the computing device two 436 for presentation on the display two 440.

In some implementations, if the display one 438 fails, the computing device manager 432 transmits the information previously sent to the computing device one 434 to the computing device two 436. The computing device two 436 then generates content 442 previously generated by the computing device one 434 as well as generating its own content 444. The display two 442 can display the contents 442, 444 in parallel or in a cyclic fashion as discussed previously.

FIG. 4C shows the exemplary redundancy architecture 460 in which a first computing device connected to a working display retrieves information from a second computing device connected to a faulty display. The first computing device transmits the retrieved information to the working display on behalf of the second computing device.

The redundancy architecture 460 can include a computing device one 462 that generates content for presentation on a display one 464. The redundancy architecture 460 also can include a computing device two 466 that generates content for presentation on display two 468. The computing devices one and two 462, 466 are networked together as indicated by the network line 470.

If the display one 464 fails, the computing device two 466 can request 472 the content that was generated by the computing device one 462. In response to the request, the computing device one 462 can transmit 474 the generated content from the computing device one 462 to the computing device two 466. The computing device two 466 can then transmit both the content 476 from the computing device one 462 and its own content 478 for display on the display two 468.

In some implementations, the architecture 460 differs from the redundancy architecture 430 of FIG. 4B in that content information is retrieved from a computing device coupled to a defective monitor instead of receiving the content information (e.g., the actual content or information used to generate the content) from a computing device manager 432, which may in turn receive the information from a remote server.

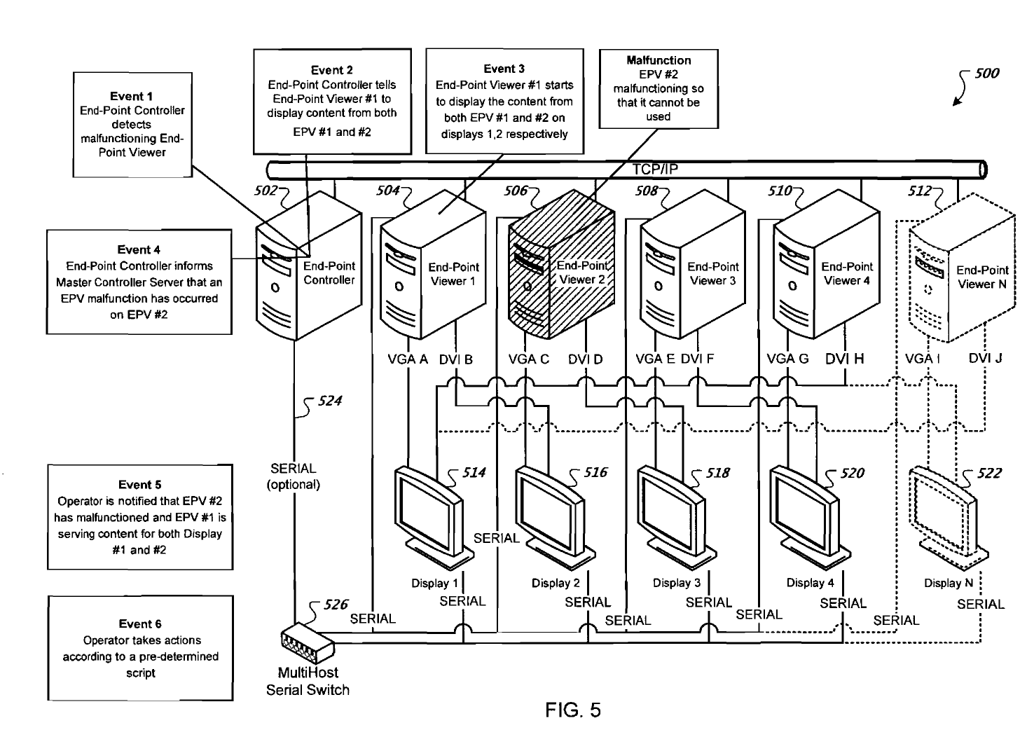

FIG. 5 is a schematic of an exemplary digital signage system 500 used to mitigate failures in computing devices used to generate media for presentation on display devices. The digital signage system 500 includes an end-point controller 502; end-point viewers 504, 506, 508, 510, 512; displays 514, 516, 518, 520, and 522; and a serial switch 526. In the implementation of FIG. 5, the digital signage system 500 has architecture substantially similar to the architecture previously described in association with the digital signage system 200 of FIG. 2.

In some implementations, if a computing device, such as the end-point viewer 506 fails, the working end-point viewer 504 can generate content previously generated by the failed end-point viewer 506. The working end-point viewer 504 can transmit the content previously generated by the failed end-point viewer 506 for presentation on the display 516 (which displayed the content before the failure of the end-point viewer 506).

For example, the working end-point viewer 504 can have two outputs—a primary output to the display one 514 and a secondary output to the display two 516. The working end-point viewer 504 can transmit the content previously generated by the failed end-point viewer 506 to the display two 516 using the secondary output while continuing to output its own content via the primary output.

Although FIGS. 2 and 5 indicate that the primary and secondary outputs are VGA and DVI, this is not limiting and is only given as an example. In another example, the end-point viewer 544 can include two video cards that each output a VGA signal. One video card can transmit content generated by the working end-point viewer and the other video card can transmit the content for which the working end-point viewer has assumed responsibility.

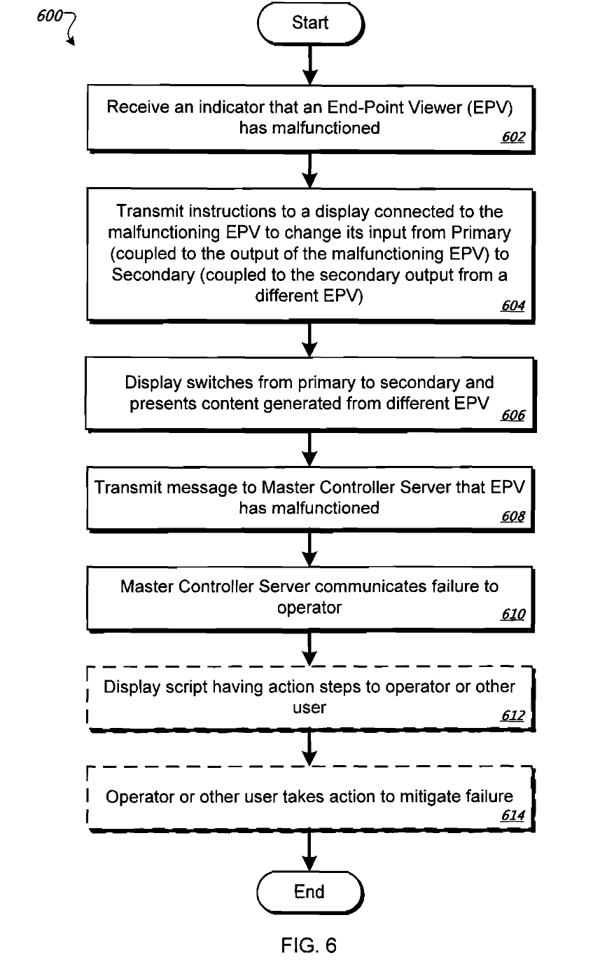

FIG. 6 is flow chart of an exemplary method 600 for mitigating the effect of a failed computing device within a digital signage system. The digital signage system of FIG. 5 can be used to implement the method 600, but the method 600 can be implemented by other systems as well. For clarity of explanation, the digital signage system 500 is used to further explain the method 600.

In step 602, an indicator is received that an end-point viewer has malfunctioned. For example, referring to FIG. 5, the end-point viewer 506 may malfunction so that it is unable to generate or transmit graphics to the display 516. The end-point controller 502 detects that the end-point viewer 506 has malfunctioned (as indicated by Event 1 in FIG. 5).

In step 604, instructions are transmitted to a display connected to the malfunctioning end-point viewer to change the display's input from primary (e.g., coupled to a primary output from the malfunctioning end-point viewer) to secondary (e.g., coupled to a secondary output from a working end-point viewer). For example, the end-point controller 502 can transmit a message to the display 516 that the display should switch inputs (as indicated by Event 2 in FIG. 5).

In some implementations, the message can instruct the display 516 to switch from accepting input transmitted from the malfunctioning end-point viewer 506 (e.g., via a VGA signal) to accepting input from the working end-point viewer 544 (e.g., via a DVI signal). Additionally, the end-point controller 502 can transmit a message to the end-point viewer 504 to start displaying content previously displayed by the failed end-point viewer 506. The new content displayed by the end-point viewer 504 can be transmitted on a secondary output (in this case a DVI output) of the end-point viewer 504.

In step 606, the display switches from the primary to the secondary input and presents content generated from the working end-point viewer. For example, the display 516 can switch its input from the VGA connection with the failed end-point viewer 546 to the DVI connection with the working end-point viewer 504 (as indicated by Event 3 in FIG. 5). Then the display 516 can present the content transmitted via the connection with the working end-point viewer 504.

In step 608, a message is transmitted to a master controller server that the end-point viewer has malfunction. For example, the end-point controller 502 transmits a command to remote server such as the master controller server 114 of FIG. 1 (as indicated by Event 4 in FIG. 5). The command can include information about the failed end-point viewer 506. The information can include but is not limited to a location of the failed end-point viewer, an error code a associated with the failure, and whether another end-point viewer is operating in a failover capacity for the failed end-point viewer (as indicated by event 5 in FIG. 5).

In some implementations, the remaining steps 610, 612, and 614 are substantially similar to the steps 312, 314, and 316 of FIG. 3 as previously described. After step 614, the method 600 can end.

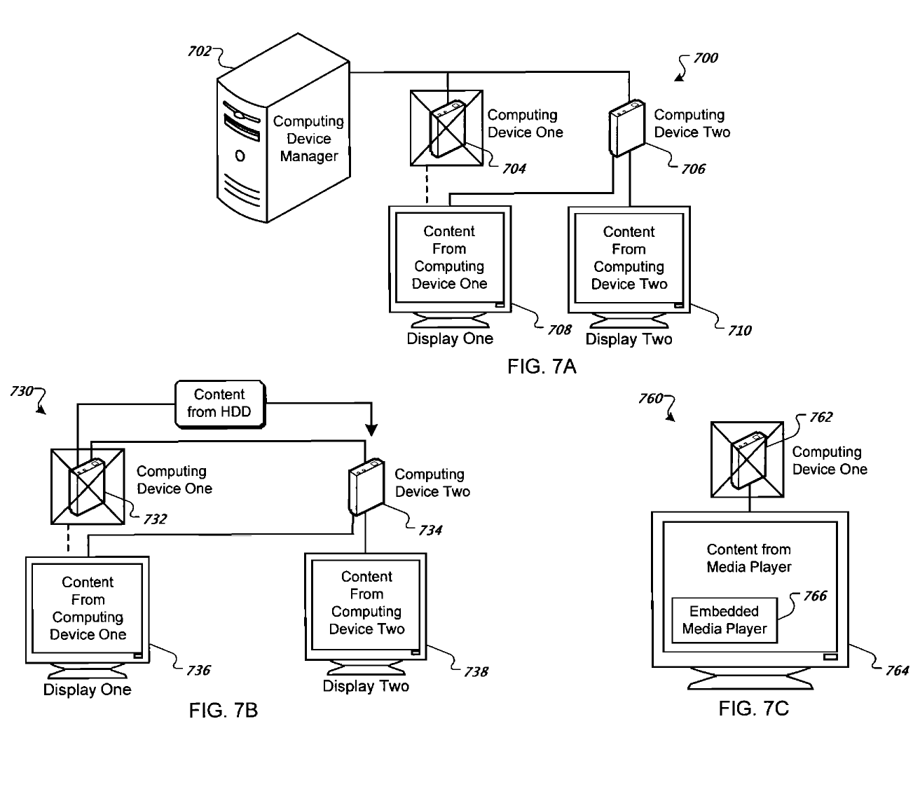

FIGS. 7A-C show exemplary redundant architectures 700, 730, 760 for mitigating a computing device failure. FIG. 7A is the exemplary redundancy architecture 700. In the architecture 700, a working computing device receives information from a computing device manager and uses the information to generate content previously generated by another computing device that has failed.

The architecture 700 includes a computing device manager 702, a computing device one 704, a computing device two 706, a display one 708, and a display two 710. In one implementation, the computing device manager 702 can receive information (or pre-generated content) through a wide area network such as the Internet. The computing device manger 702 can then pass the information to the computing devices 704, 706. The computing devices 704, 706 can use the information to generate content for presentation on the displays 708, 710, respectively.

If the computing device 704 fails, the working computing device two 706 can accept information from the computing device manager 702 that was previously transmitted to the failed computing device one 704. The computing device 702 can use the information to generate content for display on the display one 708. The computing device two 706 can also continue to generate its own content which is transmitted to display two 710 for presentation.

In some implementations, the computing device two 706 has two video signal outputs. A secondary, or alternate, output that goes to the display one 708 and a primary output that goes to the display two 710. When the computing device 704 is functioning properly, the computing device two can transmit solely using the primary output. If the computing device one 704 malfunctions, the computing device two 706 can transmit content using both its primary and alternative outputs. More specifically, the computing device two 706 can generate content previously generated by the malfunctioning computing device one 704 and transmits this content via the alternative output for presentation on the display one 708. Additionally, the computing device two 706 continues to generate its own content and outputs the content via the primary output for presentation on the display two 710.

As discussed previously, the display one 708 can include two inputs—a primary input coupled to the computing device one 704 and an alternate input coupled to the computing device two 706. Upon failure of the computing device one 704, the monitor can switch inputs so that the video transmission is received from the working computing device two 706 via the alternative input.

In one implementation, although not shown, the display one 708 can receive a command to switch inputs from the computing device manager 702 through a serial or other network. In another implementation, the display one 708 can detect that the computing device one 704 is not correctly transmitting a video signal and can self-switch so that the video signal is received from the alternative input.

FIG. 7B shows an exemplary redundancy architecture 730. The redundancy architecture 730 includes a computing device one 732, a computing device two 734, a display one 736, and a display two 738. The computing device one 732 can generate content for presentation on the display one 736, and the computing device two 734 can generate content for presentation on the display two 738. In the event that the computing device one 732 fails, the computing device to 734 can retrieve the generated content from the computing device one 734 and display it on behalf of the failed computing device.

For example, the computing device two 734 can access a hard drive of the computing device two 734 to retrieve content (e.g. via a local area network) that was generated by the computing device two 734. The computing device two 734 can transmit the retrieved content through an alternative output that couples the computing device two 734 to the display one 736. In parallel to outputting the retrieved content to the display one 736, the computing device two 734 can continue to transmit its own generated content to the display two 738 for presentation.

FIG. 7C shows an exemplary redundancy architecture 760. The architecture 760 includes a computing device one 762 and a display 764 having an embedded media player 766. In some implementations, the embedded media player 766 includes additional hardware within the display that can store and/or generate content for presentation on the display 764. For example, the embedded media player can include non-volatile memory such as Flash memory or EEPROM and a graphics processor used to generate media for presentation.

If the computing device one 762 malfunctions, the embedded media player 766 can generate or transmit content for presentation on the display 764. For example, during normal operation (i.e., when the computing device one is functioning), the embedded media player 766 can store content received at the display 764 from the computing device one 762 in a cache for failover purposes. If the computing device one 762 fails, the embedded media player 766 can retrieve the cached content for presentation on the display 764.

Another example, the embedded media player 766 can include content that has been uploaded by a user for display in case the computing device one 762 fails. In some situations, the uploaded content is static (i.e., not dynamically updated based on content received from the computing device manager 702 as described previously in association with FIG. 7A).

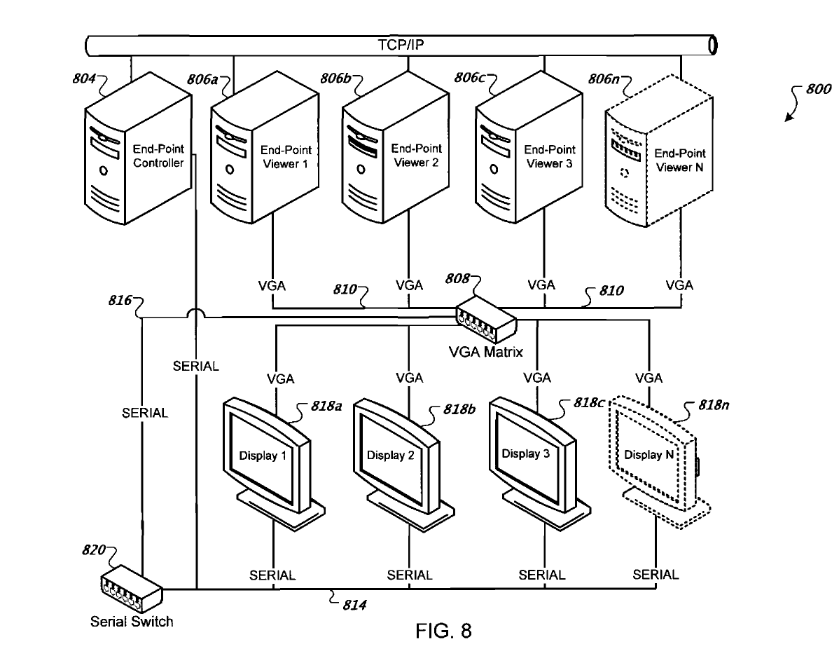

FIGS. 8-10 show exemplary arrangements using video switches to connect end-point viewers with displays. Referring to FIG. 8, there is shown a system 800 that includes a group of end-point viewers 806a-806n connected to a group of displays 818a-n in an N×N switching matrix. In this example, the video feeds from each of the end-point-viewers 806a-n may be pass on connections 810 to the switch 808, which in this example is a VGA switch but may take a number of other forms also, and then to one or more of the displays 818a-n. Generally, in this example, each viewer 806a-n will drive one corresponding display 818a-n. However, switch 808 may be used to control which of the viewers 806a-n serves which of the displays 818a-n. Also, switch 808 may cause a feed from a single viewer to be provided to multiple displays.

In this example, which of the displays 818a-n is connected to which viewer 806a-n is controlled by a signal provided on serial line 816 to the switch 808 from the end-point controller 804. Such controllable video switches are widely available and well known, and may take a variety of formats. Here, the end-point controller 804 is connected to the serial switch 820, which in turn is connected to the switch 808. In other example, the end-point controller 804 can be connected directly to the VGA switch 808 without passing through the serial switch 820.

An end-point controller 804 is provided to maintain control over the various displays 818a by controlling the switch 808. The end-point controller 804 can be networked to the end-point viewers 806a-n using a networking standard that implements Transmission Control Protocol/Internet Protocol (TCP/IP) such as Ethernet IEEE 802.3 or wireless local area network (WLAN) IEEE 802.11. Also, the network controller 804 may transmit commands through the serial line 814 to the displays 818a-n in order to execute functions such as controlling a display's presentation properties (e.g., contrast, hue, etc.) or requesting that a display change sources of input (e.g. switching from accepting a video signal from input A to accepting a video signal from input B).

In this example, however, the displays 818a-n are shown as using only a single input each, and switching occurs by the end-point controller 804 communicating control signals through serial switch 820 and serial line 816 to switch 808. For example, switching logic in the end-point controller may initially set inputs 1-2-3-4 for switch 808 to connect to outputs 1-2-3-4, respectively. A sensed failure of display 818b may then cause inputs 1 and 2 to be switched alternatively to output 1. Subsequent failure of display 818c may cause inputs 3 and 4 to be switched alternatively to output 4. Various other forms of switching logic may be employed for the same or various other failure scenarios, so that content may be displayed appropriately to viewers of the system 800 when display or server failures occur.

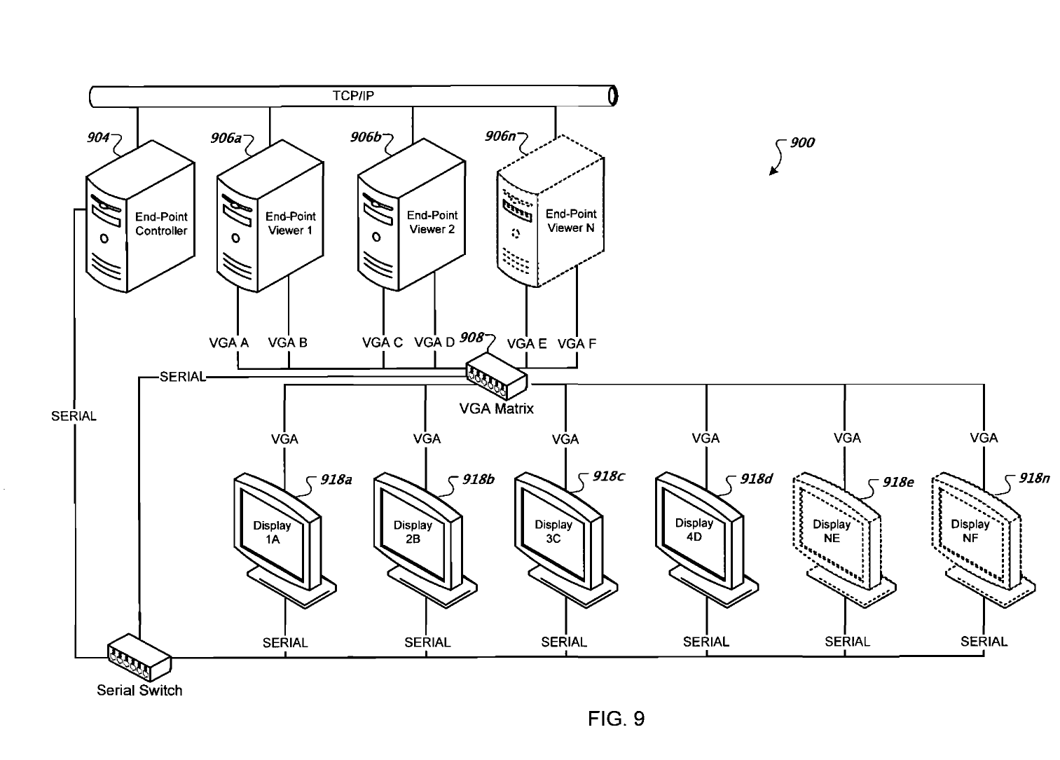

FIG. 9 shows a system 900 that includes a group of end-point viewers 906a-906n connected to a group of displays 918a-n in an M×N switching matrix. The arrangement is similar to that shown in FIG. 8, except that the number of end-point viewers 906a-n does not match the number of displays 918a-m and each end-point viewer 906a-n has two video signal lines going to the switch 908. The lack of identity between end-point viewers 906a-n and displays 918a-m can be handled in a familiar manner by splitting a signal from a single end-point viewer so that it servers multiple displays. The multiple feeds form each viewer may be used to overcome failures from one feed or to provide multiple different outputs at once from a single device. For example, one viewer may be used to drive multiple displays simultaneously, such as adjacent menu boards in a menu display for a quick serve restaurant.

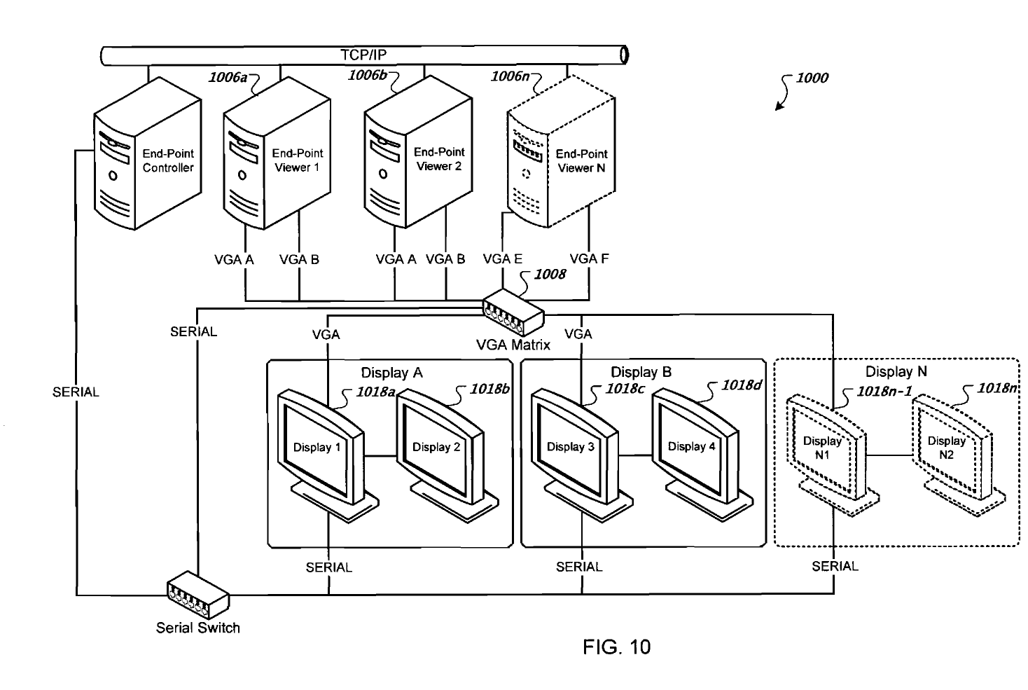

FIG. 10 shows a system 1000 that includes a group of end-point viewers 1006a-1006n connected to paired displays 1018a-n. The general arrangement of the system 1000 is similar to that of system 900 in FIG. 9, but here, each video feed out of switch 1008 serves two displays that are linked in series, as a primary display and secondary display, such as display 1018a and display 1018b. The coupled, or linked, displays can be treated as a single display. For example, a single image can be stretched across the two displays so that one portion is presented on a right display and the remaining portion is presented on a left display.

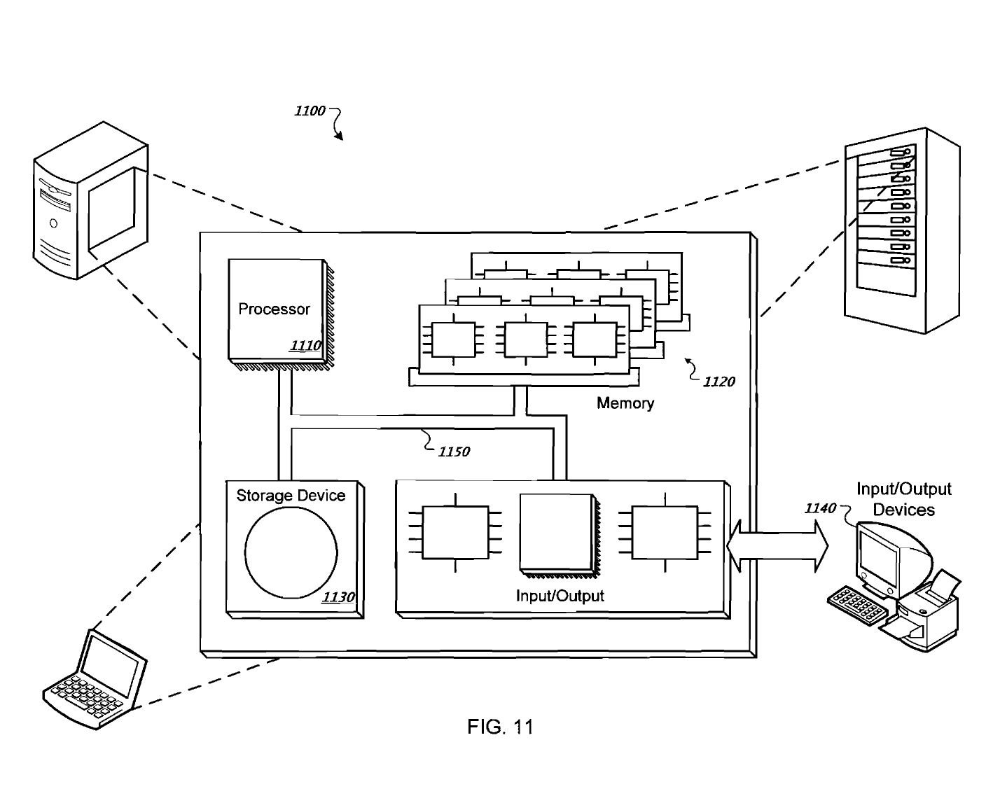

FIG. 11 is a schematic diagram of a computer system 1100. The system 1100 can be used for the operations described in association with any of the computer-implement methods described previously, according to one implementation. The system 1100 is intended to include various forms of digital computers, such as laptops, desktops, workstations, personal digital assistants, servers, blade servers, mainframes, and other appropriate computers. The system 1100 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1100 includes a processor 1110, a memory 1120, a storage device 1130, and an input/output device 1140. Each of the components 1110, 1120, 1130, and 1140 are interconnected using a system bus 1150. The processor 1110 is capable of processing instructions for execution within the system 1100. The processor may be designed using any of a number of architectures. For example, the processor 1110 may be a CISC (Complex Instruction Set Computers) processor, a RISC (Reduced Instruction Set Computer) processor, or a MISC (Minimal Instruction Set Computer) processor.

In one implementation, the processor 1110 is a single-threaded processor. In another implementation, the processor 1110 is a multi-threaded processor. The processor 1110 is capable of processing instructions stored in the memory 1120 or on the storage device 1130 to display graphical information for a user interface on the input/output device 1140.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 may be a floppy disk device, a hard disk device, an optical disk device, or a tape device.

The input/output device 1140 provides input/output operations for the system 1100. In one implementation, the input/output device 1140 includes a keyboard and/or pointing device. In another implementation, the input/output device 1140 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, if a computing device fails, a working computing device can simply output, or mirror, its own content on the display that previously received content from the failed computing device. In another implementation, if a display fails and a working display presents content for the failed display in rotation with its own content, then the timing of the rotation can be based on how much information is presented during a cycle. For example, if the working display normally presents seven menu items and the failed displayed normally presents fourteen menu items, a cycle showing the fourteen menu items may be displayed longer than (e.g., twice or three times as long) the cycle showing the seven menu items. The amount of content presented can be determined in a number of ways including the amount of data (e.g., bits) needed to represent the data or meta data indicating a number of content items (e.g., XML tags identifying content can be enumerated).

In yet another implementation, meta data can be used to directly indicate how long (absolutely or relatively) associated content should be displayed in a rotation cycle. For example, an XML tag associated with a portion of content can indicate that the content should be displayed for at least 45 seconds before cycling to other content (e.g., <cycle value=45></cycle>).

Additionally, protocols and hardware described are only exemplary and are not meant to be limiting. For example, FIG. 2 depicts VGA and DVI connections between the end-point viewers and the displays, however, other types of connections can be used such as RCA connections, unified display interface connections, DisplayPort connections, DMS-59 connections, and High-Definition Multimedia Interface connections. In other implementations, other connection topologies not previously described may be present. For example, the end-point controller 202 can connect to the displays of systems 200, 500 through Ethernet or wireless connections in addition to or instead of the serial connections shown in FIGS. 2 and 5.

Also, the systems and methods described above can handle simultaneous failures of multiple components. For example, in some situations, more than one display may fail in the system 200. For example, both display 216 and display 218 may fail. In this case, the end-point viewer 206 can transmit content for display on the functional display 220 through a third connection (not shown). In other situations, multiple end-point viewers may fail. For example, the end-point viewer 506 and the end-point viewer 510 may fail. In this case, the end-point viewer 504 can transmit content to the display 516 on behalf of the failed end-point viewer 506 and the end-point viewer 508 can transmit content to the display 520 on behalf of the failed end-point viewer 510. Additionally, failover protection against other failure variations are possible such as simultaneous failure of a display and an end-point viewer.

In some implementations, the described systems can be updated to reflect when a previously malfunctioning device begins working again. For example, if the display 216 of FIG. 2 fails, the end-point viewer 206 may transmit content to the display 218 for presentation. If the display 216 starts functioning (e.g., the display is replaced, power is restored to the display, etc.), the end-point viewer 206 may detect this and reroute the content back to the display 216. For example, the end-point viewer 206 can continue to transmit periodic queries to the display 216 regarding a display state. If the display 216 responds at all (or specifically that it is able to present the content), the end-point viewer 206 can switch its output so that the content is transmitted to the display 216. Additionally, in some implementations, a notification that the previously failed device is now working can be transmitted, for example, to the master controller server 114 in a similar manner as described for the transmission of failure indicators.

The displays and computing devices described above are not intended to be limiting. Other systems can implement the failover processes previously described. For example, the previously described systems may incorporate displays that include emergency signs, exit signs, building directories, air port terminals, convention center information boards, or in other environments were information is presented.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
transmitting content to a location for presentation across a plurality of display devices that each present a portion of the content;
receiving an indication that a first portion of the content managed by a first computing device is unable to be presented on a first display device; and
transmitting a command to display the first portion on a second display device, which is configured to present a second portion of the content, if the received indication specifies that the first display device experienced a failure or transmitting a command that the first portion be displayed on the first display device using a second computing device if the received indication specifies that the first computing device experienced a failure.

2. The method of claim 1, wherein the first and second portions are presented in rotation on the second display device if the first display device fails.

3. The method of claim 2, wherein the rotation comprises scrolling the first portion and the second portion across the second display device.

4. The method of claim 2, wherein the rotation comprises replacing the first portion with the second portion so that the first and second portions are not simultaneously visible on the second display device.

5. The method of claim 1, wherein the first and second portions are presented substantially in parallel on the second display device if the first display device fails.

6. The method of claim 1, further comprising transmitting a command to the first computing device to switch output from a primary connection with the first display device to an alternate connection with the second display device if the first display device fails.

7. The method of claim 1, further comprising transmitting a command to the second computing device to retrieve the first portion managed by the first computing device for presentation on the second display device if the first display device fails.

8. The method of claim 1, further comprising transmitting information to the second computing device for use in generating the first portion of the content previously generated by the first computing device if the first display fails.

9. The method of claim 1, further comprising transmitting the generated first portion from the second computing device to the second display device.

10. The method of claim 1, further comprising transmitting, from the second computing device, the first portion to the first display device and the second portion to the second display device if the first computing device fails.

11. The method of claim 1, further comprising transmitting a command to the first display device to switch input from a primary connection with the first computing device to an alternative connection with the second computing device if the first computing device fails.

12. The method of claim 1, further comprising transmitting to a remote server an indication that the first computing device or the first display device has experienced a failure.

13. The method of claim 12, further comprising transmitting an alert that notifies a service technician of the failure.

14. The method of claim 1, wherein a controller server that manages the first and second computing devices receives the indication that the first portion of the content managed by the first computing device is unable to be presented on the first display device.

15. The method of claim 14, further comprising receiving at a remote server an indication that the controller server has experienced a failure.

16. The method of claim 15, further comprising transmitting an alert to notify a user of the failure of the controller server.

17. The method of claim 1, wherein the second computing device comprises an embedded media player associated with the first display that transmits the first portion for presentation on the first display device if the first computing device fails.

18. The method of claim 1, further comprising designating particular content items as permissible for cycling with other content items or designating particular content items as non-permissible for cycling.

19. The method of claim 18, further comprising grouping content items based on whether the content items are designated as permissible or non-permissible for cycling.

20. The method of claim 1, further comprising transmitting content items designated as non-permissible for cycling a third display device for presentation without cycling with other content and transmitting the content items designated as permissible to the second display.

21. A computer-implemented method comprising:
receiving an indication that content associated with a first computing device is unable to be presented on a first display device;
determining whether the inability to present the content is based on a failure of the first computing device to generate the content or a failure of the first display device to present the content;
transmitting a command to a second computing device to generate the content for presentation on the first display if the inability to present content is based on the failure of the first computing device; and
transmitting a command to a second display device to present the content associated with the first computing device if the inability to present the content is based on the failure of the first display device.

22. A system comprising:
an on-site controller to
transmit content for presentation across a plurality of display devices that each present a portion of the content and
receive an indication that a first portion of the content managed by a first computing device is unable to be presented on a first display device;
a second display device configured to present a second portion of the content, wherein the second display device also presents the first portion if the first display device experiences a failure; and
a second computing device configured to manage a second portion of the content, wherein the second computing device manages the first portion of the content if the first computing device experiences a failure.

23. The system of claim 22, wherein the second computing device is coupled to the first and second display devices and the second display device is coupled to both the first and second computing devices.
